(19) United States
(12) Patent Application Publication
(10) Pub. No.: US 2014/0244729 A1
(43) Pub. Date: Aug. 28, 2014

(54) GROUP MANAGING SYSTEM AND PROGRAM

(71) Applicant: TOKYO ELECTRON LIMITED, Tokyo (JP)

(72) Inventors: Kenji MATOGAWA, Sapporo City (JP); Shingo SEKISAWA, Iwate (JP); Miki OHUCHI, Iwate (JP); Kenji YOSHINO, Iwate (JP)

(73) Assignee: TOKYO ELECTRON LIMITED, Tokyo (JP)

(21) Appl. No.: 14/184,858

(22) Filed: Feb. 20, 2014

(30) Foreign Application Priority Data
Feb. 22, 2013 (JP) 2013-033492

(51) Int. Cl. H04L 29/08

(52) U.S. Cl. CPC H04L 67/10
USPC 709/203

(57) ABSTRACT

Disclosed is a group managing system with a client device. The client device includes an input reception unit that receives an input from a user; a process information reception unit that specifies a server connected to the client device and receives the process information sent from the server connected thereto; an input screen preparation unit that stores information related to the input screen for the client device and registers the process information in the input screen information to prepare an input screen for the client device; a display unit that displays the client screen for the client device; and a processing request information sending unit that sends processing request information to the server when a processing content from the input reception unit is received to the input screen for the client device displayed on the display unit and the processing request information is prepared on the input screen for the client device.

### CROSS-REFERENCE TO RELATED APPLICATIONS

This application is based on and claims priority from Japanese Patent Application No. 2013-033492, filed on Feb. 22, 2013, with the Japan Patent Office, the disclosure of which is incorporated herein in its entirety by reference.

### TECHNICAL FIELD

The present disclosure relates to a group managing system and a group managing program.

### BACKGROUND

A group managing system is provided with at least one manufacturing equipment configured to carry out a predetermined semiconductor process on a workpiece to be processed (“workpiece”), at least one server connected to the manufacturing equipment, and at least one client device connected to the server. The group managing system may manage manufacturing equipment such as a semiconductor manufacturing equipment or a liquid crystal panel manufacturing equipment. Various proposals have been presented so as to efficiently manage the manufacturing equipment. For example, Japanese Patent Laid-Open Publication No. H11-354395 (Patent Document 1) discloses a group managing system configured to detect an abnormality in an inspection target group (e.g., a duration, an apparatus group, a recipe group or a parameter group) which is set by a user, and then acquire overall inspection data for the inspection target group such that a user may analyze the abnormality.

### SUMMARY

According to an aspect of the present disclosure, there is provided a group managing system that includes: at least one manufacturing equipment configured to carry out a predetermined process on a workpiece to be processed; at least one server connected to the at least one manufacturing equipment; and at least one client device connected to the at least one server. The at least one server includes: a process information sending unit configured to send process information related to a process, which may be executed by the manufacturing equipment, to the manufacturing equipment in response to an instruction from the server. The at least one client device includes: an input reception unit configured to receive an input from a user; a process information reception unit configured to specify a server connected to the client device and receive the process information sent from the server connected thereto; an input screen preparation unit configured to prepare an input screen for the client device, the input screen preparation unit being configured to store therein information concerning the input screen for the client device and register the process information in the input screen information received by the process information reception unit; a display unit configured to display the client screen for the client device which is prepared by the input screen preparation unit; and a processing request information sending unit configured to send processing request information to the server when a processing content from the input reception unit is received to the input screen for the client device displayed on the display unit and the processing request information is prepared on the input screen for the client device. The at least one server further includes: a processing request information reception unit configured to receive the processing request information sent from the processing request information sending unit; a command execution unit configured to configure command information to give a command to a corresponding manufacturing equipment based on the processing request information received by the processing request information reception unit; and a command information sending unit configured to send the command information, which is configured by the command execution unit, to the corresponding manufacturing equipment. The corresponding manufacturing equipment controls each component thereof to carry out a process according the command information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a configuration of a group managing system according to an exemplary embodiment of the present disclosure.

FIG. 2 is a view illustrating an example of manufacturing equipment illustrated in FIG. 1.

FIG. 3 is a view illustrating a configuration of a server illustrated in FIG. 1.

FIG. 4 is a view illustrating a configuration of a client device illustrated in FIG. 1.

FIG. 5 is a view illustrating an example of an input screen for a client device.

FIG. 6 is a view illustrating a flow chart for describing a process of preparing an input screen for a client device.

FIG. 7 is a view illustrating an example of a conventional input screen.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made without departing from the spirit or scope of the subject matter presented here.

In the group managing system as described above, when an object sever is selected and then an application is selected, the selected application may be activated. However, when a plurality of severs are registered in an operation terminal of the group managing system, it may be difficult for a system user to select an application to be activated. For this reason, the user's load may increase or erroneous operations may occur.

The present disclosure has been made in an effort to solve the problems as described above and the present disclosure provides a group managing system and a group managing program capable of reducing the user's load and erroneous operations.

A group managing system according to a first aspect of the present disclosure includes: at least one manufacturing equipment configured to carry out a predetermined process on a workpiece to be processed; at least one server connected to the at least one manufacturing equipment; and at least one client device connected to the at least one server. The at least one server includes: a process information sending unit configured to send process information related to a process, which may be executed by the manufacturing equipment, to the manufacturing equipment in response to an instruction from the server. The at least one client device includes: an input reception unit configured to receive an input from a user; a process information reception unit configured to specify a server connected to the client device and receive the process information sent from the server connected thereto; an input screen preparation unit configured to prepare an input screen for the client device, the input screen preparation unit being configured to store therein information concerning the input screen for the client device and register the process information in the input screen information received by the process information reception unit; a display unit configured to display the client screen for the client device which is prepared by the input screen preparation unit; and a processing request information sending unit configured to send processing request information to the server when a processing content from the input reception unit is received to the input screen for the client device displayed on the display unit and the processing request information is prepared on the input screen for the client device. The at least one server further includes: a processing request information reception unit configured to receive the processing request information sent from the processing request information sending unit; a command execution unit configured to configure command information to give a command to a corresponding manufacturing equipment based on the processing request information received by the processing request information reception unit; and a command information sending unit configured to send the command information configured by the command execution unit to the corresponding manufacturing equipment. The corresponding manufacturing equipment controls each component thereof to carry out a process according the command information.

For example, the input screen preparation unit may arrange an icon that activates the input screen for the client device at a desktop of the display unit.

For example, the input screen preparation unit may prepare the input screen for the client device which is divided for each server.

For example, the input screen preparation unit may prepare the input screen for the client device to be displayed on a single screen of the display unit.

According to a second aspect of the present disclosure, there is provided A computer-readable program storage medium storing a computer-readable program that when executed, causes a computer to function as a group managing system which includes at least one manufacturing equipment configured to carry out a predetermined process on a workpiece to be processed, at least one server connected to the at least one manufacturing equipment, and at least one client device connected to the at least one server. In the computer, the server executes: a process information sending step of sending process information related to a process, which may be executed by the manufacturing equipment, to the client device in response to an instruction from the server. The client device executes: an input reception step of receiving an input from a user; a process information reception step of specifying a server connected to the client device and receiving the process information sent from the connected server; an input screen generation step of preparing an input screen for the client device by storing therein information concerning the input screen for the client device and registering the process information in the input screen information received by the process information reception unit; a displaying step of displaying the client screen for the client device which is prepared by the input screen preparation unit; and a processing request information sending step of sending processing request information to the server when a processing content from the input reception unit is received to the input screen for the client device displayed on the display unit to prepare the processing request information on the input screen for the client device. The server further executes: a processing request information reception step of receiving the processing request information sent from the processing request information sending unit; a command execution step of configuring command information to give a command to a corresponding manufacturing equipment based on the processing request information received by the processing request information reception unit; and a command information sending step of sending the command information configured by the command execution unit to the corresponding manufacturing equipment. The corresponding manufacturing equipment controls each component thereof to carry out a process according the command information.

According to the present disclosure, a user's load and erroneous operations may be reduced.

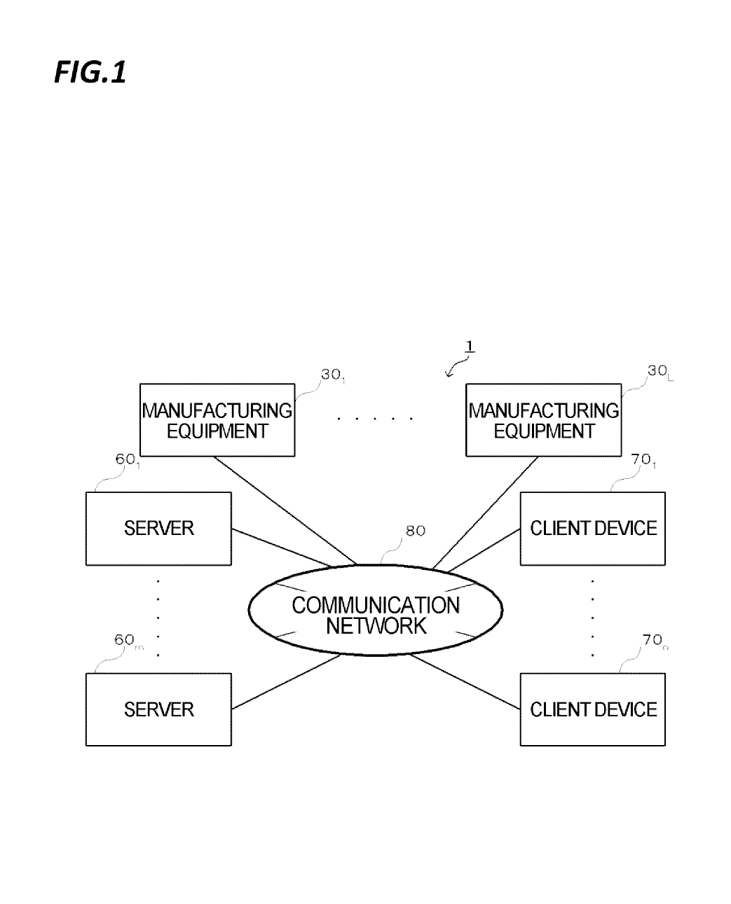

Hereinafter, a group managing system and a group managing program according to the present disclosure will be described with reference to the accompanying drawings. FIG. 1 is a block diagram illustrating a configuration of a group managing system according to an exemplary embodiment.

As illustrated in FIG. 1, a group managing system 1 according to the present exemplary embodiment may include L manufacturing equipment 30, M servers 60, and N client devices 70. Here, each of L, M and N is an integer which is equal to or larger than 1. The L manufacturing equipment 30, the M servers 60, and the N client devices 70 may be connected to one another such that they may communicate with each other via a wired or wireless communication network 80. The communication network 80 may include, for example, the Internet, an intranet, and a public telephone network.

Each manufacturing equipment 30 may carry out a given semiconductor process on a workpiece. The manufacturing equipment 30 may be, for example, a semiconductor manufacturing equipment, a liquid crystal panel manufacturing equipment, an organic electroluminescence (EL) display manufacturing equipment, or a plasma display panel manufacturing equipment. The workpiece may be, for example, a wafer or a flat panel display (“FPD”) substrate. The FPD substrate may be, for example, a glass substrate. As long as the semiconductor process carried out using the manufacturing equipment 30 includes at least one process related to a semiconductor, a pre-process or a post-process thereof may be or may not be included. The process carried out on the workpiece may be, for example, a film forming process, an etching process, or a thermal oxidation process.

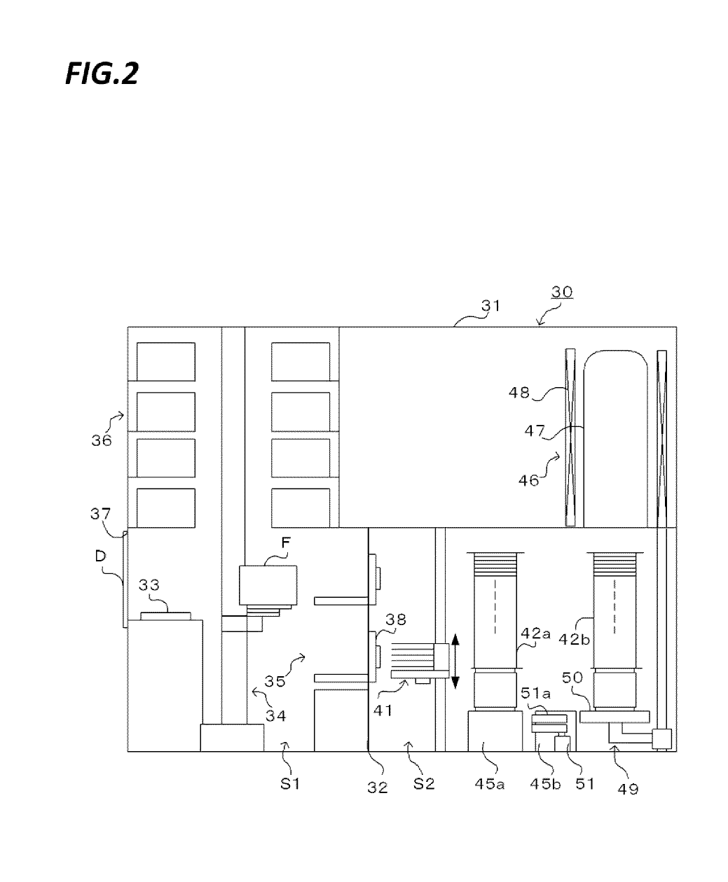

The manufacturing equipment 30 may be, for example, a batch-type vertical heat treatment apparatus. FIG. 2 illustrates an example of the manufacturing equipment 30. As shown in FIG. 2, the manufacturing equipment 30 may include a processing chamber 31 divided into a working region S1 and a loading region S2 by a partition wall 32. The working region S1 is a region in which a front opening unified pod (“FOUP”) F as a hermetic conveying container configured to accommodate a plurality of (e.g., 25) semiconductor wafers W is conveyed or stored. The working region S1 is maintained under an air atmosphere. Meanwhile, the loading region S2 is a region in which a heat treatment including, for example, a film forming process or an oxidation process, is performed on the semiconductor wafers W. The loading region S2 may be may be maintained under an inert gas atmosphere, for example, a N₂ gas atmosphere.

The working region S1 may be provided with a load port 33, a FOUP conveyor 34, a transfer stage 35, and a storage unit 36.

A FOUP, which is carried into the processing chamber 31 through a conveying opening 37 formed at a side of the processing chamber 31 by an external conveyor (not illustrated), may be mounted on the load port 33. A door D is installed outside the processing chamber 31 at a position corresponding to the conveying opening 37 and the conveying opening 37 may be closed or opened by the door D.

The FOUP conveyor 34 is installed between the load port 33 and the transfer stage 35 so as to convey FOUPs F in the working region S1. The FOUP conveyor 34 conveys a FOUP F mounted on the load port 33 to the storage unit 36 which is installed above the working region S1, and conveys a FOUP F stored in the storage unit 36 to the transfer stage 35.

The transfer stage 35 is installed at the working region S1 side of the partition wall 32 and a FOUP F conveyed into the working region S1 by the FOUP conveyor 34 is mounted on the transfer stage 35. In the transfer stage 35, semiconductor wafers W are taken out from the inside of the FOUP F to the loading region S2 by a transfer mechanism 41 which will be described later. The partition wall 32 positioned at a side of the transfer stage 35 is formed with an opening and a shutter 38 is installed at the loading region S2 side of the partition wall so as to block the opening.

In the loading region S2, the transfer mechanism 41, a wafer boat 42, a boat mounting table(s) 45(45a, 45b), and a boat transfer mechanism 51 are installed.

The transfer mechanism 41 is installed between the shutter 38 and the boat mounting table 45a so as to transfer the semiconductor wafers W between the FOUP F mounted on the transfer stage 35 and the wafer boat 42 mounted on the boat mounting table 45a.

Each of the boat mounting tables 45a, 45b is configured such that an wafer boat 42 is mounted thereon. There are provided, for example, two boat mounting tables 45a, 45b, i.e. a transfer boat mounting table 45a where a wafer boat 42, from which the semiconductor wafers W are transferred by the transfer mechanism 41, is mounted and a standby boat mounting table 45b where a standby wafer boat 42b is mounted. Further, there are provided a plurality of (e.g., two) wafer boats 42, i.e. wafer boats 42a, 42b which are alternately used.

A heat treatment furnace 46 includes a processing container 47 configured by a cylindrical body which is made of quartz and has an opening formed through a bottom wall thereof and a ceiling. A cylindrical heater 48 is installed around the processing container 47 to be capable of heating semiconductor wafers W in the processing container 47. A cap 50 configured to be moved up and down by a lift mechanism 49 is disposed under the processing container 47. When a wafer boat 42 that accommodates semiconductor wafers W therein is disposed on the cap 50 and moved up, the semiconductor wafers W are loaded in the processing container 47. With this loading, the opening of the bottom of the processing container 47 is hermetically blocked by the cap 50.

The boat transfer mechanism 51 is provided in the vicinity of the boat mounting tables 45a, 45b. The boat transfer mechanism 51 is provided with an arm 51a configured to be movable backward and forward so as to transfer the wafer boat 42 between the boat mounting table 45a or 45b and the cap 50.

In the present exemplary embodiment, process-related information (e.g., a recipe) related to a semiconductor process is stored in a server 60. However, the manufacturing equipment 30 may store, for example, a recipe therein so as to carry out a process control using the recipe.

The at least one server 60(60₁ to 60ₘ) configures the group managing system 1 and may store therein various information sent from manufacturing equipment 30. In addition, the server 60 may carry out a processing in response to a request from the client device 70 or the manufacturing equipment 30 and properly send a result of the processing to the client device 70 or the manufacturing equipment 30.

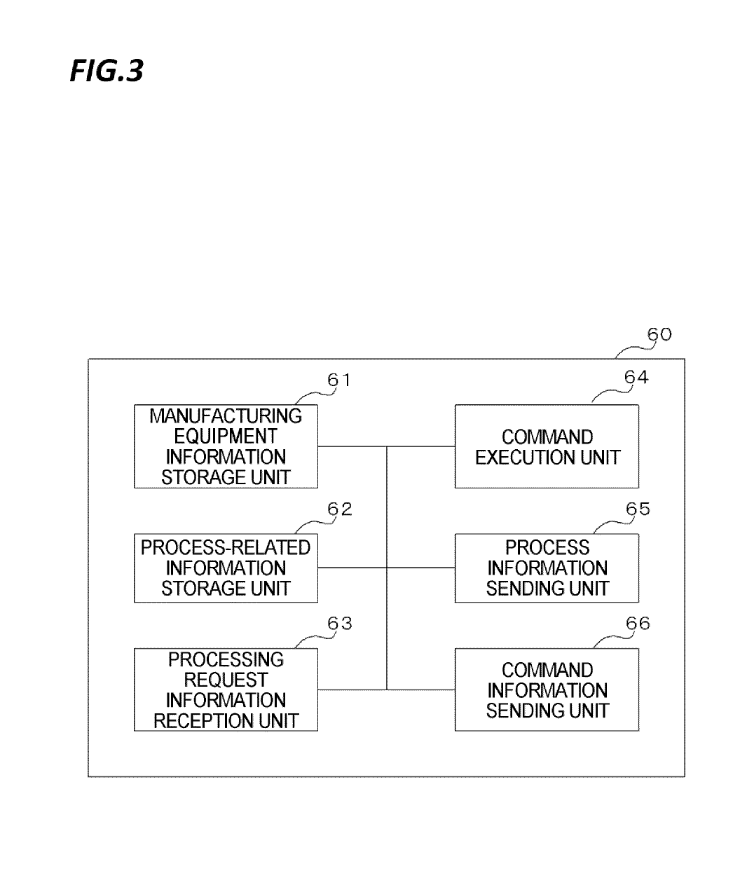

FIG. 3 illustrates a configuration of a server 60. As illustrated in FIG. 3, the server 60 is provided with a manufacturing equipment information storage unit 61, a process-related information storage unit 62, a processing request information reception unit 63, a command execution unit 64, a process information sending unit 65, and a command information sending unit 66. In the present exemplary embodiment, only the characteristic parts of the group managing system 1 according to the present disclosure will be clearly described and descriptions on the other parts will omitted. For example, the server 60 may include a component that receives information such as, for example, a temperature and a pressure in a manufacturing process in manufacturing equipment 30, which is a component that executes a given semiconductor process on a workpiece, from the manufacturing equipment 30.

The manufacturing equipment information storage unit 61 is stored with manufacturing equipment information related to manufacturing equipment 30 connected to the server 60 via the communication network 80. The manufacturing equipment information may be, for example, identification information of the manufacturing equipment 30. The manufacturing equipment information storage unit 61 is stored with a semiconductor process available by the manufacturing equipment 30.

The process-related information storage unit 62 is stored with process-related information which is related to a semiconductor process such as, for example, a recipe and a manufacturing parameter which are used in the manufacturing equipment 30 connected to the server 60 via the communication network 80. The process-related information storage unit 62 is stored with at least one piece of process-related information. The recipe is information used so as to determine, for example, semiconductor process conditions (e.g., a processing time and a kind of a processing gas). The manufacturing parameters may be, for example, numerical values (e.g., a numerical value representing an upper or lower limit of a set temperature) required for operating the manufacturing equipment 30.

The process-related information storage unit 62 may store the information in a random access memory (“RAM”) temporarily or in a long term. The process-related information storage unit 62 may be implemented using a predetermined storage medium (e.g., a semiconductor memory, a magnetic disk, or an optical disk). When process-related information is stored in the process-related information storage unit 62, for example, the process-related information may be stored in the process-related information storage unit 62 through a storage medium, the process-related information may be transmitted via, for example, the communication network 80, and stored in the process-related information storage unit 62, or the process-related information may be input through an input device and stored in the process-related information storage unit 62.

The processing request information reception unit 63 receives process request information that requests a desired processing which is related to the process-related information. The processing request information reception unit 63 may receive, for example, processing request information which is input from an input device (e.g., a keyboard, a mouse or a touch panel), may receive processing request information which is transmitted via a wired or wireless communication line, or may receive the processing request information which is read from a predetermined storage medium (e.g., a semiconductor memory, a magnetic disk, or an optical disk). In the present exemplary embodiment, the processing request information reception unit 63 receives the processing request information transmitted from a client device 70.

The command execution unit 64 configures command information according to the processing request information to give a command to manufacturing equipment 30, and sends the command information to the manufacturing equipment 30. Specifically, the command execution unit 64 configures the command information in response to the command included in the processing request information received by the processing request information reception unit 63. Then, the command execution unit 64 instructs the command information sending unit 66 to send the configured command information to the manufacturing equipment 30 included in the processing request information which is received by the processing request information reception unit 63.

Here, the command included in the command information corresponds to a command that includes the processing request information received by the processing request information reception unit 63 and may be executed by the manufacturing equipment 30. For example, the command execution unit 64 may configure the command information to include a recipe which is related to the processing. The command execution unit 64 may be implemented typically using a memory. A processing sequence of the command execution unit 64 may be implemented typically by software. The software is stored in a storage medium such as a hard disc drive (“HDD”) or a ROM. Alternatively, the processing sequence of the command execution unit 64 may be implemented by hardware (a dedicated circuit).

The process information sending unit 65 sends the information related to a process, which may be performed by manufacturing equipment 30, to the client device 70 in response to an instruction from the server 60. The process information sending unit 65 sends the process-related information (an application) related to a process to be performed by the manufacturing equipment 30.

The command information sending unit 66 may send the command information configured by the command execution unit 64 based on the processing request information received by the processing request information reception unit 63, to manufacturing equipment 30. Upon receiving information of transmission destinations of a plurality of manufacturing equipment 30, the command information sending unit 66 sends the command information to the plurality of transmission destinations.

The at least one client device 70 requests various processings from a server 60 or manufacturing equipment 30. The client device 70 may receive processing results on the request from the server or the manufacturing equipment.

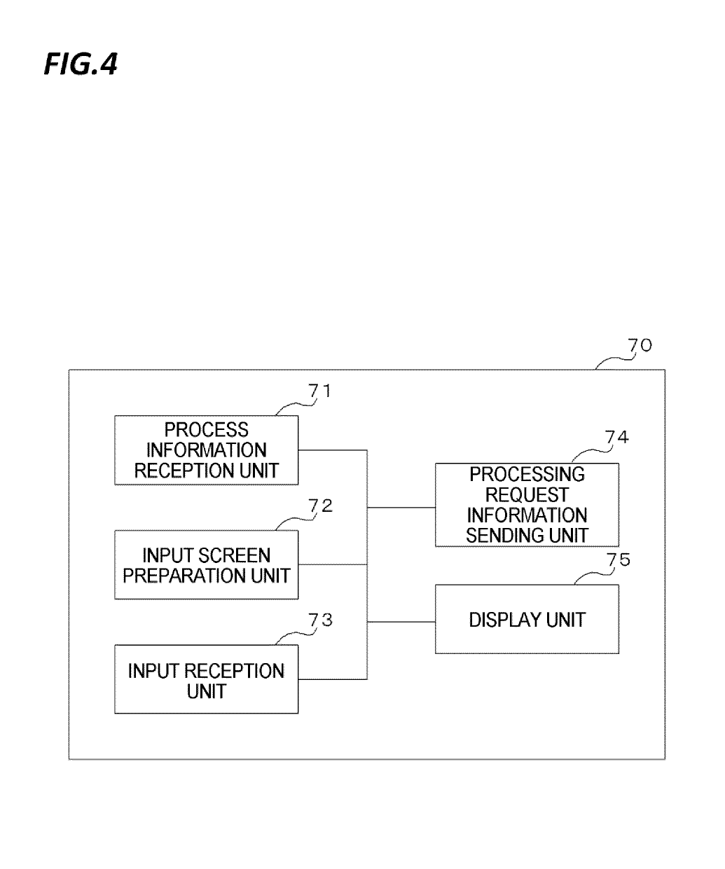

FIG. 4 illustrates a configuration of a client device 70. As shown in FIG. 4, the client device 70 may include a process information reception unit 71, an input screen preparation unit 72, an input reception unit 73, a processing request information sending unit 74, and a display unit 75. In addition, in the present exemplary embodiment, only the characteristic components of the group managing system 1 of the present disclosure will be described and descriptions of other components will be omitted as in the description of the at least one server 60.

The process information reception unit 71 specifies a server 60 connected to a corresponding client device 70 and receives the process information from the server 60 (the process information sending unit 65) connected to a client device 70. In addition, the process information reception unit 71 may include a wired or wireless reception device (e.g., a modem or a network card) which is configured to receive the process information. The process information reception unit 71 may be implemented by hardware or implemented by software of, for example, a driver that drives the reception device.

The input screen preparation unit 72 may prepare an input screen for a client device 70. The input screen preparation unit 72 is provided with an image information file that stores information to configure images displayed in a processing to be described below and stores, for example, images of various materials and various forms in order to prepare the images. The input screen preparation unit 72 stores, for example, an image related to an input screen, paths of application execution files and detailed descriptions of the applications. The input screen preparation unit 72 may prepare an input screen for the client device 70 based on the process information received by the process information reception unit 71 and an image (an image for the input screen) stored in an image information database. A process of preparing the input screen for the client device 70 by the input screen preparation unit 72 will be described below.

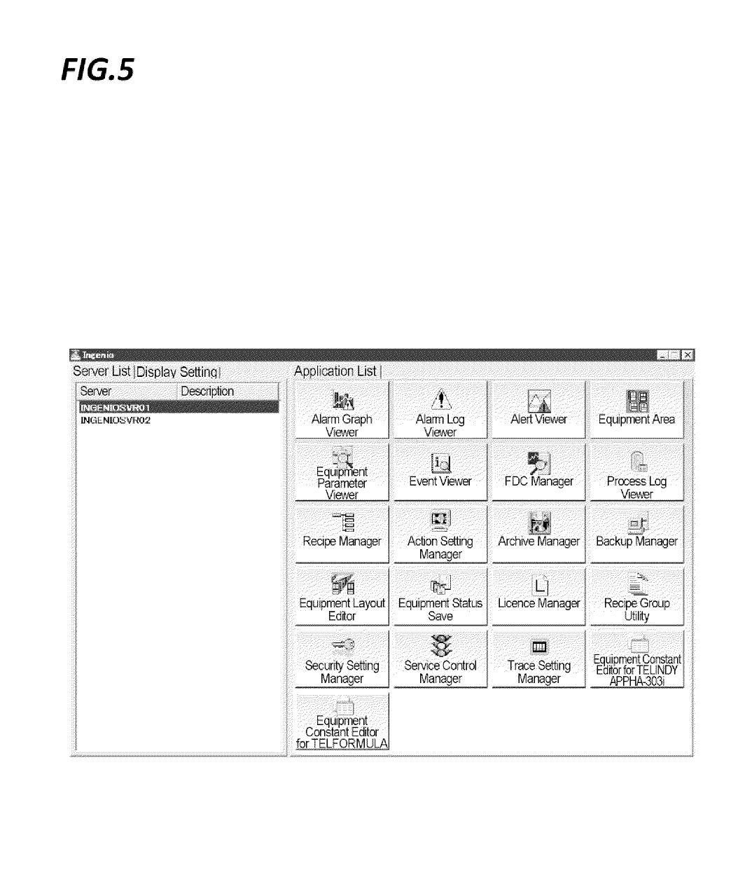

FIG. 5 illustrates one example of an input screen for a client device 70. As illustrated in FIG. 5, the input screen for the client device 70 is prepared to include a list of the process-related information (applications), which is related to a process to be performed, for each server 60. Thus, the applications may be easily selected and activated with a little number of times of operations. As a result, the user's load and erroneous operations may be reduced. An icon which activates the input screen for the client device 70 is arranged preferably at a desktop of the display unit 75. With this arrangement, the user' load may be further reduced.

The input reception unit 73 may receive an input from the user who operates the client device 70. The input reception unit 73 may receive, for example, information input from an input device (e.g., a keyboard, a mouse or a touch panel), information transmitted through a wired or wireless communication line, or information read from a predetermined storage medium (e.g., a semiconductor memory, a magnetic disk, or an optical disk). In the present exemplary embodiment, the input reception unit 73 receives the input from the input device.

The processing request information sending unit 74 may send processing request information received by the input reception unit 73 to a server 60. The processing request information sending unit 74 may have a sending device (e.g., a modem or a network card) so as to send the processing request information. The processing request information sending unit 74 may be implemented by hardware, or by software of, for example, a driver that drives the sending device.

The display unit 75 displays various images such as, for example, the input screen for the client device 70 prepared by the input screen preparation unit 72. As described above, the icon which activates the input screen for the client device 70 may be arranged at the desktop of the display unit 75. The display unit 75 may or may not include a display device (e.g., a cathode ray tube (CRT) or a liquid crystal display (LCD)) so as to display the images described above. The display unit 75 may be implemented by hardware, or software of, for example, a driver that drives the display device.

In the present exemplary embodiment, it is described that a processing request information input screen is sent from a server 60 and processing request information is sent from a client device 70. However, such information may be sent to/received from manufacturing equipment 30. In such a case, the manufacturing equipment 30 may have the same configuration as that of the client device 70 as illustrated in FIG. 4. In the present exemplary embodiment, a detailed description on the manufacturing equipment 30 is omitted.

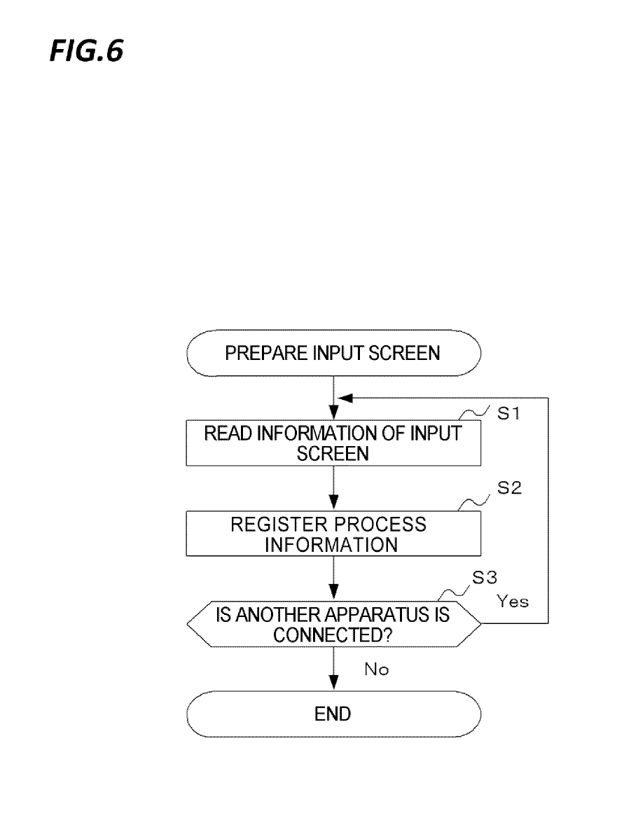

Now, descriptions will be made on a process of preparing an input screen for a client device 70 which is prepared by a input screen preparation unit 72. FIG. 6 illustrates a flowchart for describing a process of preparing an input screen for a client device 70. In the present example, it is assumed that a client device 70₁ is connected to servers 60₁, 60₂.

First, the input screen preparation unit 72 reads information related to the input screen for the client device 70₁ from an image information database (step S1). Next, the input screen preparation unit 72 registers process information, which is related to one server 60₁ received by the process information reception unit 71, in the information of the input screen for the client device 70 which is read by the input screen preparation unit 72 (step S2). As a result, an input screen related to the one server 60₁ is prepared.

Subsequently, the input screen preparation unit 72 determines whether the other server 60₂ is connected to the client device 70₁ (step S3). For example, the input screen preparation unit 72 determines whether input screens about all the servers 60₁, 60₂ connected to the client device 70₁ specified by the process information reception unit 71 are prepared.

Since the other server 60₂ is connected to the client device 70₁ (“Yes” at step S3), the input screen preparation unit 72 returns back to step S1 and prepares an input screen for the other server 60₂ (steps S1 and S2). In addition, the input screen preparation unit 72 determines whether another server is connected to the client device 70₁ (step S3). In the present example, since no other server is connected to the client device 70₁ (“No” at step S3), the input screen preparation unit 72 terminates the process. In this manner, the input screen for the client device 70₁ as illustrated in FIG. 5 is prepared in which an input screen is prepared for each client device and for each user who is logging in the client device.

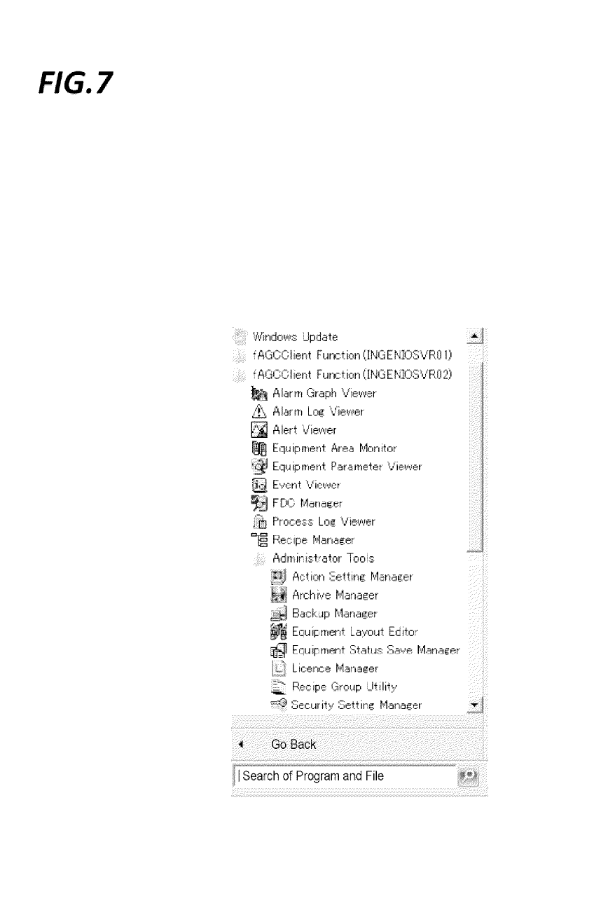

FIG. 7 illustrates an example of a conventional input screen. Referring to FIGS. 5 and 7, a input screen prepared for a client device 70 displays a list of process-related information (applications), which is related processes to be performed, for each server 60. Thus, a user who uses the client device 70 may easily select an application and activates the application with a little number of times of operations as compared with the conventional input screen. Thus, the user's load and erroneous operations may be reduced.

In addition, an icon which activates the input screen for the client device 70 is arranged preferably at the desktop of the display unit 75. With this arrangement, the user' load may be further reduced.

Now, operations of the group managing system 1 in accordance with the present exemplary embodiment will be described.

First, the user activates the corresponding client device 70 and operates, for example, the input reception unit 73 so as to select the icon displayed on the desktop of the display unit 75. Then, an input screen for the client device 70 is displayed on the display unit 75. Next, the user inputs a desired content of a processing to the input screen for the client device 70 by operating the input reception unit 73 so as to prepare processing request information. Next, the prepared processing request information is sent to a corresponding sever 60 via the communication network 80.

When the processing request information is sent to the corresponding server 60, the processing request information reception unit 63 receives the processing request information sent from the server 60. Then, the command execution unit 64 prepares command information that gives a command to a corresponding manufacturing equipment 30 according to the received processing request information. Further, a recipe related to the processing is contained in the command information by the command execution unit 64. Then, the command information sending unit 66 sends the prepared command information to a corresponding manufacturing equipment 30 via the communication network 80.

When the command information is sent to the manufacturing equipment 30, a control unit of the manufacturing equipment 30 controls each component of the manufacturing equipment 30 to execute the processing according to the recipe.

As described above, in accordance with the present exemplary embodiment, an input screen of a client device 70 displays a list of applications using icons for each server 60. Thus, the user who uses the client device 70 easily selects an application and activates the application with a little number of times of operations as compared with the conventional input screen. As a result, the user's load and erroneous operations may be reduced.

The present disclosure is not limited to the above described exemplary embodiment, and various modifications or applications may be apparent to a person ordinarily skilled in the art. Hereinafter, other exemplary embodiments of the present disclosure will be described.

In the above-described exemplary embodiment, it has been described that an input screen of a client device 70 displays a list of applications for each server 60 as icons, as an example. However, the input screen of the client device 70 may display a list of applications for each server 60 on a single screen. Further, the list of applications may not be displayed as icons.

The configurations of the manufacturing equipment 30, the severs 60 and the client devices 70 that form the group managing system 1 are not limited to those in the above-described exemplary embodiment. The group managing system may include a component other than the components described in the above-described exemplary embodiment. For example, in the above-described exemplary embodiment, when at least two components included in a severs 60 or manufacturing equipment 30 includes a communication device or an input device, the at least two components may share a physically single device or include their own devices, respectively.

In the above-described exemplary embodiment, respective processings or functions may be implemented by being carried out either in an centralized manner using a single apparatus or a single system or in a distributed manner using a plurality of apparatuses or systems.

In the above-described exemplary embodiment, descriptions have been made mainly based on a case where process-related information is recipes or parameters used in manufacturing equipment 30. However, the process-related information may be information other than those related to a semiconductor process in the manufacturing equipment 30.

A control according to an exemplary embodiment of the present disclosure may be implemented using an ordinary computer system regardless of a dedicated system. For example, when computer programs configured to perform the above-described processes are stored in a storage medium such as, for example, a flexible disc (FD) or a compact disc read only memory (CD-ROM), a control unit configured to carry out the above-described processes may be configured by installing the computer programs in a general purpose computer.

Means for supplying such computer programs are optional. The programs may be supplied, for example, through a communication line, a communication network or a communication system as well as a predetermined storage medium as described above. In such a case, the computer programs may be uploaded on, for example, a bulletin board system (BBS) of a communication network and distributed through the network. When the computer programs provided in this manner are activated and executed under a control of an operating system (OS) like other application programs, the above-described processes may be executed.

The present disclosure may be properly applied to a group managing system including at least one manufacturing equipment configured to carry out a predetermined process on a workpiece, at least one sever connected to the manufacturing equipment, and at least one client device connected to the sever.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A group managing system comprising:
at least one manufacturing equipment configured to carry out a predetermined process on a workpiece to be processed;
at least one server connected to the at least one manufacturing equipment; and
at least one client device connected to the at least one server,
wherein the server includes:
a process information sending unit configured to send process information related to a process, which may be executed by the manufacturing equipment, the manufacturing equipment in response to an instruction from the server,
the client device includes:
an input reception unit configured to receive an input from a user;
a process information reception unit configured to specify a server connected to the client device and receive the process information sent from the server connected thereto;
an input screen preparation unit configured to prepare an input screen for the client device, the input screen preparation unit being configured to store therein information concerning the input screen for the client device and register the process information in the input screen information received by the process information reception unit;
a display unit configured to display the client screen for the client device which is prepared by the input screen preparation unit; and
a processing request information sending unit configured to send processing request information to the server when a processing content from the input reception unit is received to the input screen for the client device displayed on the display unit and the processing request information is prepared on the input screen for the client device,
the server further includes:
a processing request information reception unit configured to receive the processing request information sent from the processing request information sending unit;
a command execution unit configured to configure command information to give a command to a corresponding manufacturing equipment based on the processing request information received by the processing request information reception unit; and
a command information sending unit configured to send the command information, which is configured by the command execution unit, to the corresponding manufacturing equipment, and
wherein the corresponding manufacturing equipment controls each component thereof to carry out a process according the command information.

2. The group managing system of claim 1, wherein the input screen preparation unit arranges an icon that activates the input screen for the client device at a desktop of the display unit.

3. The group managing system of claim 1, wherein the input screen preparation unit prepares the input screen for the client device to be divided for each server.

4. The group managing system of claim 1, wherein the input screen preparation unit prepares a client device input screen to be displayed on a single screen of the display unit.

5. A computer-readable program storage medium storing a computer-readable program that when executed, causes a computer to function as a group managing system which includes at least one manufacturing equipment configured to carry out a predetermined process on a workpiece to be processed, at least one server connected to the at least one manufacturing equipment, and at least one client device connected to the at least one server, wherein, in the computer,
the server executes: a process information sending step of sending process information, which is related to a process to be capable of being executed by the manufacturing equipment, to the client device in response to an instruction from the server,
the client device executes: an input reception step of receiving an input from a user; a process information reception step of specifying a server connected to the client device and receiving the process information sent from the connected server; an input screen generation step of preparing an input screen for the client device by storing therein information concerning the input screen for the client device and registering the process information in the input screen information received by the process information reception unit; a displaying step of displaying the client screen for the client device which is prepared by the input screen preparation unit; and a processing request information sending step of sending processing request information to the server when a processing content from the input reception unit is received to the input screen for the client device displayed on the display unit to prepare the processing request information on the input screen for the client device, and
the server further executes: a processing request information reception step of receiving the processing request information sent from the processing request information sending unit; a command execution step of configuring command information to give a command to a corresponding manufacturing equipment based on the processing request information received by the processing request information reception unit; and a command information sending step of sending the command information configured by the command execution unit to the corresponding manufacturing equipment, and
wherein the corresponding manufacturing equipment controls each component thereof to carry out a process according the command information.
